(19) United States
(12) Patent Application Publication
(10) Pub. No.: US 2017/0221612 A1
(43) Pub. Date: Aug. 3, 2017

(54) VARISTOR HAVING MULTILAYER COATING AND FABRICATION METHOD

(71) Applicant: Dongguan Littelfuse Electronics, Co., Ltd., GuangDong (CN)

(72) Inventors: Wen Yang, Guangdong Province (CN); Cheng Hao, Shaanxi Province (CN); Yan'an Wu, JiangXi Province (CN)

(21) Appl. No.: 15/501,091

(22) PCT Filed: Aug. 8, 2014
(86) PCT No.: PCT/CN2014/083974

§ 371 Date: Feb. 1, 2017

(51) Int. Cl. H01C 7/102; H01C 17/065; H01C 7/112

(52) U.S. Cl. CPC H01C 7/102; H01C 7/112; H01C 17/06546; H01C 17/06586; H01C 17/285

(57) ABSTRACT

In one embodiment a varistor may include a ceramic body. The varistor may further comprise a multilayer coating disposed around the ceramic body. The multilayer coating may include an outer layer comprising an epoxy material. The multilayer coating may also include an inner layer that is adjacent the ceramic body and is disposed between the outer layer and the ceramic body. The inner layer may comprise a polymeric material that is composed of an acrylic component.

### BACKGROUND OF THE INVENTION

Field of the Invention

Embodiments of the invention relate to the field of circuit protection devices. More particularly, the present invention relates to a metal oxide varistor for surge protection.

Discussion of Related Art

Over-voltage protection devices are used to protect electronic circuits and components from damage due to over-voltage fault conditions. These over-voltage protection devices may include metal oxide varistors (MOVs) that are connected between the circuits to be protected and a ground line. MOVs have a unique current-voltage characteristic that allows them to be used to protect such circuits against catastrophic voltage surges. However, because varistor devices are so widely deployed to protect many different type of apparatus, there is a continuing need to improve properties of varistors.

A MOV device is generally composed of a ceramic disc, often based upon ZnO, an Ag (silver) electrode, and a first and second metal lead connected at a first surface and second surface that opposes the first surface. The MOV device is also provided with an insulation coating that surrounds the ceramic disc and other materials in many cases. An example of an MOV found in the present market includes a ceramic disc that is coated with epoxy insulation, which has high dielectric strength.

However, this type of MOV is typically restricted for operation at relatively low temperature, such as less than 85° C., and more particularly exhibits reliability problems when operated at bias humidity conditions such as 85° C., 85% relative humidity (RH) and high DC operating voltage. It is believed that the reliability problems experienced under such a bias humidity condition arise from the migration of silver electrode material used to contact surfaces of the ceramic body of the MOV, as well as from the interaction between the epoxy coating and ZnO ceramic. An example of the reliability problems is the increased leakage through the interface when an epoxy-coated MOV is operated at high temperature (at least 85° C.), high humidity conditions while applying DC operating voltage. It is with respect to these and other issues that the present improvements may be desirable.

### SUMMARY

Exemplary embodiments are directed to improved varistors. In one embodiment a varistor may include a ceramic body. The varistor may further include a multilayer coating disposed around the ceramic body. The multilayer coating may include an outer layer comprising an epoxy material. The multilayer coating may also include an inner layer that is adjacent the ceramic body and is disposed between the outer layer and the ceramic body. The inner layer may comprise a polymeric material that is composed of an acrylic component.

In another embodiment, a method of forming a varistor may include providing a ceramic body and applying a first layer on the ceramic body, where the first layer includes an acrylic component. The method may further include applying a second layer to the first layer, where the second layer comprises an epoxy material.

### BRIEF DESCRIPTION OF THE DRAWINGS

FIG. 1 presents an infrared spectrum of an exemplary lacquer layer that may be used as an inner layer of a two-layer coating for a metal oxide varistor (MOV) in accordance with embodiments of the disclosure.

FIG. 2A presents a plan view of a MOV according to embodiments of the disclosure.

FIG. 2B presents a plan view of another MOV according to embodiments of the disclosure.

FIG. 2C presents a side cross-sectional view of the MOV of FIG. 2B.

FIG. 3 depicts a plan view of a conventional MOV.

FIG. 4A provides the results of electrical measurements of a MOV arranged with a two-layer coating according to the present embodiments at the initial stage.

FIG. 4B provides the results of electrical measurements of the MOV of FIG. 4A after 168 hours under bias conditions.

FIG. 4C provides the results of electrical measurements of the MOV of FIG. 4A after 336 hours under bias conditions.

FIG. 4D provides the results of electrical measurements of the MOV of FIG. 4A after 500 hours under bias conditions.

FIG. 5A provides the results of electrical measurements of a conventional MOV arranged with a single layer epoxy coating at an initial stage.

FIG. 5B provides the results of electrical measurements of the MOV of FIG. 5A after 168 hours under bias conditions.

FIG. 5C provides the results of electrical measurements of the MOV of FIG. 5A after 336 hours under bias conditions.

FIG. 5D provides the results of electrical measurements of the MOV of FIG. 5A after 500 hours under bias conditions.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with each other. However, “on,”, “overlying,” “disposed on,” and over, may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

The present embodiments are generally related to metal oxide varistors (MOV) based upon zinc oxide materials. As is known, a varistor of this type comprises a ceramic body whose microstructure includes zinc oxide grains and may include various other components such as other metal oxides that are disposed within the ceramic microstructure. By the way of background, MOVs are primarily comprised of zinc oxide granules that are sintered together to form a disc where the zinc oxide granule, as a solid, is a highly conductive material, while the intergranular boundary formed of other oxides is highly resistive. Only at those points where zinc oxide granules meet does sintering produce a ‘microvaristor’ which is comparable to symmetrical Zener diodes. The electrical behavior of a metal oxide varistor results from the number of microvaristors connected in series or in parallel. The sintered body of a MOV also explains its high electrical load capacity which permits high absorption of energy and thus, exceptionally high surge current handling capability.

The aforementioned materials that are employed to contact or encapsulate a ceramic body of the varistor are potential sources of device degradation, especially when operated at high temperature, high humidity, and/or high voltage conditions. In various embodiments, an improved varistor is provided that is resistant to degradation under conditions such as high temperature, high humidity or high voltage. In various embodiments, a MOV is provided that has a coating composed of a multilayer structure, and in particular a two layer structure that is composed of an outer layer that is composed of epoxy, and an inner layer that is composed of a lacquer. This multilayer coating may improve resistance to leakage and other electrical degradation as compared to conventional MOVs in which the ceramic is in direct contact with an epoxy coating.

Examples of a suitable lacquer layer to serve as an inner layer in a two-layer coating include a layer composed of a mixture of acrylic resin with other resin, such as amino resin. In particular embodiments, the lacquer layer may be composed of a so-called three-proofing lacquer that is moisture-proof, corrosion-proof, and mould-proof. One exemplary formulation for a lacquer to be used as an inner layer of a two-layer coating is: 40% acrylic resin, 7% amino resin, 35% xylol, 16% additional solvent, and 2% curing agent. After curing, solvents such as xylol and other solvents may be removed from the resulting lacquer layer. The acrylic resin and amino resin may react to form a lacquer layer that is composed of a polymeric material such as a thermoset polymer, where the polymer is composed of an acrylic component and an amino component. The ratio of acrylic component to amino component may be similar to or the same as the ratio of acrylic resin to amino resin used to form the lacquer. Accordingly, the ratio of acrylic component to amino component in the cured lacquer layer may be 40:7 or approximately 6:1. In other embodiments, the ratio of acrylic component to amino component may vary between 3:1 and 19:1. The embodiments are not limited in this context. For example, the present embodiments cover other ratios of acrylic:amine components in which the amine component is sufficient to provide a cross-linked thermoset polymeric material after curing.

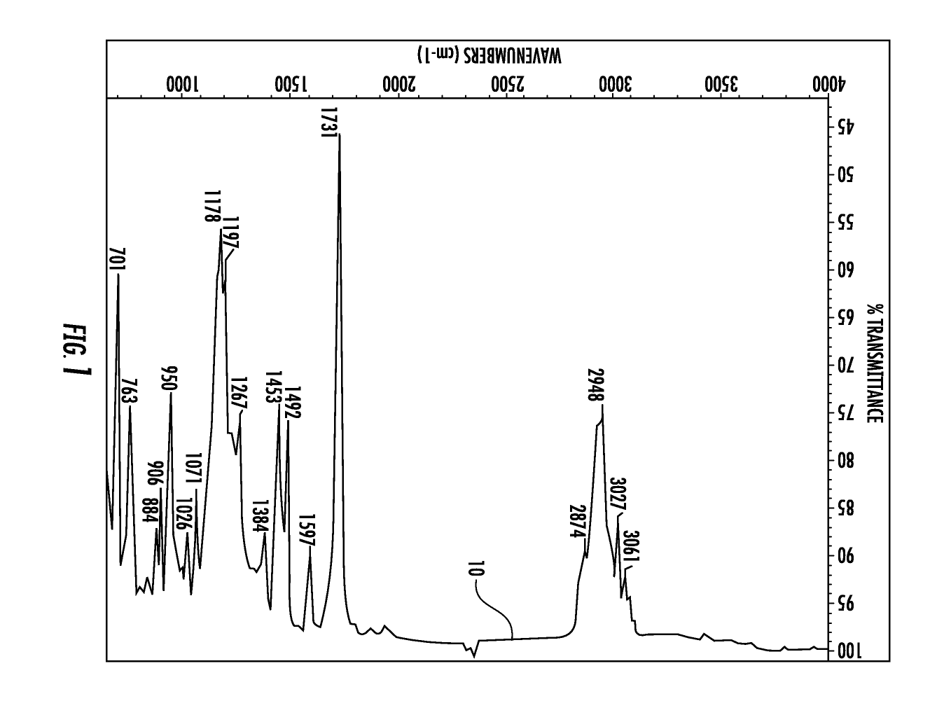

FIG. 1 presents an infrared spectrum 10 of an exemplary lacquer layer that may be used as an inner layer of a two-layer coating for a MOV in accordance with embodiments of the disclosure. As illustrated, the infrared spectrum 10 includes a plurality of absorption bands that are characteristic of a polymeric material composed of amino and acrylic components.

In one embodiment, in order to form a MOV, a lacquer layer is applied on a ceramic varistor body, which lacquer layer may be a three-proofing lacquer based upon acrylic resin and amine resin as described above. In some embodiments, the lacquer formulation may be a prepared commercial formulation that is applied at the time of coating of the varistor ceramic body, while in other embodiments, the lacquer formulation may be prepared at the time of coating of the varistor. In one example, the lacquer layer may be applied in a manner to coat exposed surfaces of the ceramic body so that subsequent layer(s) do not come into contact with the ceramic body. An advantage of a lacquer formulation such as the exemplary formulation disclosed above, is that the lacquer formulation has a low viscosity that can be applied by brush coating, spray coating, dip coating, curtain coating, or other method. Moreover, such a formulation may exhibit good adhesion. In addition, solidification into a solid lacquer layer may take place at a relatively rapid rate.

Subsequently, an epoxy layer may be applied to cover the lacquer layer. Examples of suitable epoxy for the epoxy layer include known epoxy materials that are used to form conventional MOV devices. The epoxy layer may encapsulate the lacquer-coated ceramic body so as to protect the ceramic body, such as by providing high dielectric strength.

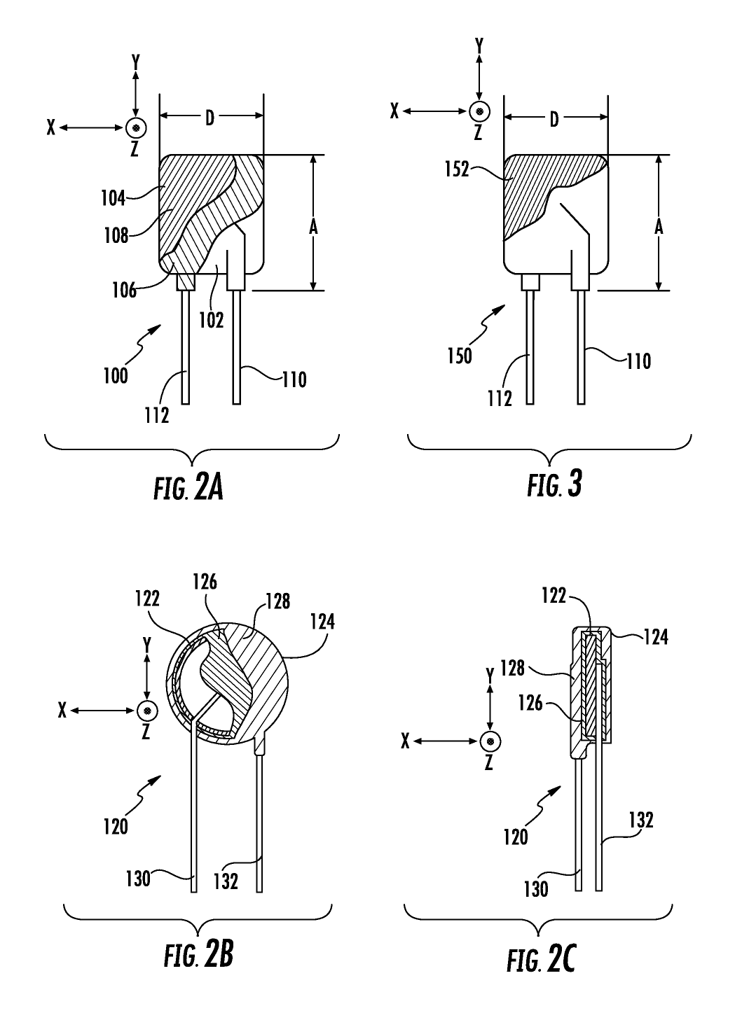

FIG. 2A presents a plan view of a MOV, varistor 100, according to embodiments of the disclosure. For clarity, a portion of the varistor coating is removed to illustrate the structure of the coating. As illustrated the varistor 100 includes a ceramic body 102, which may have a flat shape in which the ceramic body 102 lies generally in the X-Y plane as shown. The ceramic body 102 may have a conventional shape such as a generally rectangular shape having a length A and width D as shown. However, in other embodiments, the ceramic body may have an oval shape, a round shape, or other shape as known in the art. The embodiments are not limited in this context. As shown in FIG. 2, a first lead 110 may contact an upper surface of the ceramic body 102, while a second lead 112 contacts a lower surface (not visible) of the ceramic body 102. The ceramic body 102 is covered with a two-layer coating 104, as illustrated. It will be understood that the two-layer coating 104 may extend to cover the ceramic body 102 on all sides of the ceramic body 102. The two-layer coating 104 includes an inner layer 106 and outer layer 108. In various embodiments, the outer layer 108 is composed of a conventional epoxy material, which may be used to coat a conventional MOV device. The outer layer 108 may additionally have a thickness characteristic of conventional MOV devices. In some examples the thickness of the outer layer may range from 0.3 mm to 3 mm, and more particularly 0.5 mm to 1.2 mm. For a given sample, the thickness of the outer layer 108 may be uniform; however, the thickness of the outer layer 108 may vary over different regions of a MOV device as in conventional MOV devices. The embodiments are not limited in this context.

The inner layer 106 may be composed of a lacquer, such as a lacquer formed from an acrylic resin and amine resin as described above. In some embodiments, the thickness of the inner layer 106 may be in the range of 3 μm 100 μm, and in particular may be 5-50 μm. The embodiments are not limited in this context. Accordingly, it may be apparent that the application of the inner layer does not substantially alter the overall thickness of a two-layer coating according to the present embodiments in comparison to a single layer conventional epoxy coating. In other words, in some instances, the inner layer 106 has a thickness which may range from about 0.4% to 10% of the thickness of the outer layer 108.

FIG. 2B presents a plan view of another MOV, varistor 120, according to additional embodiments of the disclosure. FIG. 2C presents a side cross-sectional view of the varistor 120. For clarity, a portion of the varistor coating is removed to illustrate the structure of the coating. In this embodiment, the ceramic body 122 has a round shape. As shown in FIGS. 2B and 2C, a first lead 130 may contact an upper surface of the ceramic body 122, while a second lead 132 contacts a lower surface of the ceramic body 122. A two layer coating 124 includes an inner layer 126 and outer layer 128, which may be composed of similar materials as inner layer 106 and outer layer 108, respectively. The thickness of inner layer 126 may also fall within the range of 3 μm 100 μm and outer layer 128 may have a thickness in the range of 0.3 mm to 3 mm.

FIG. 3 depicts a conventional MOV 150, which may be composed of similar components to MOV 100, except that the ceramic body 102 is coated with a single layer, epoxy layer 152, which may be similar or the same as outer layer 108 of MOV 100.

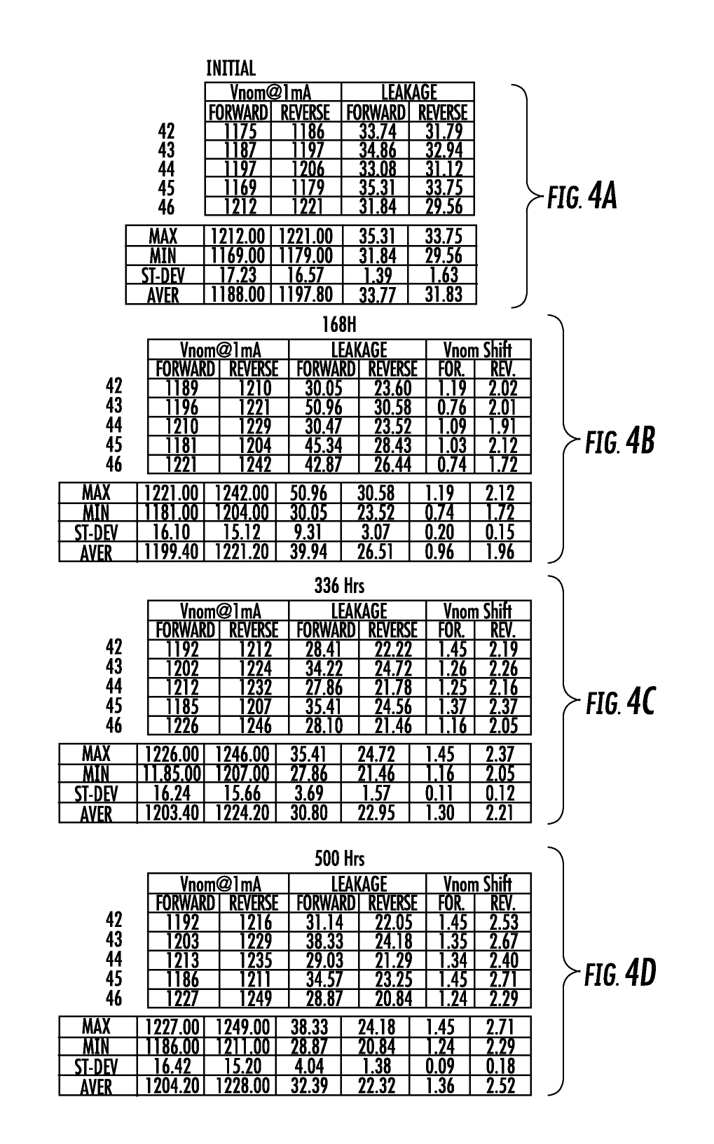

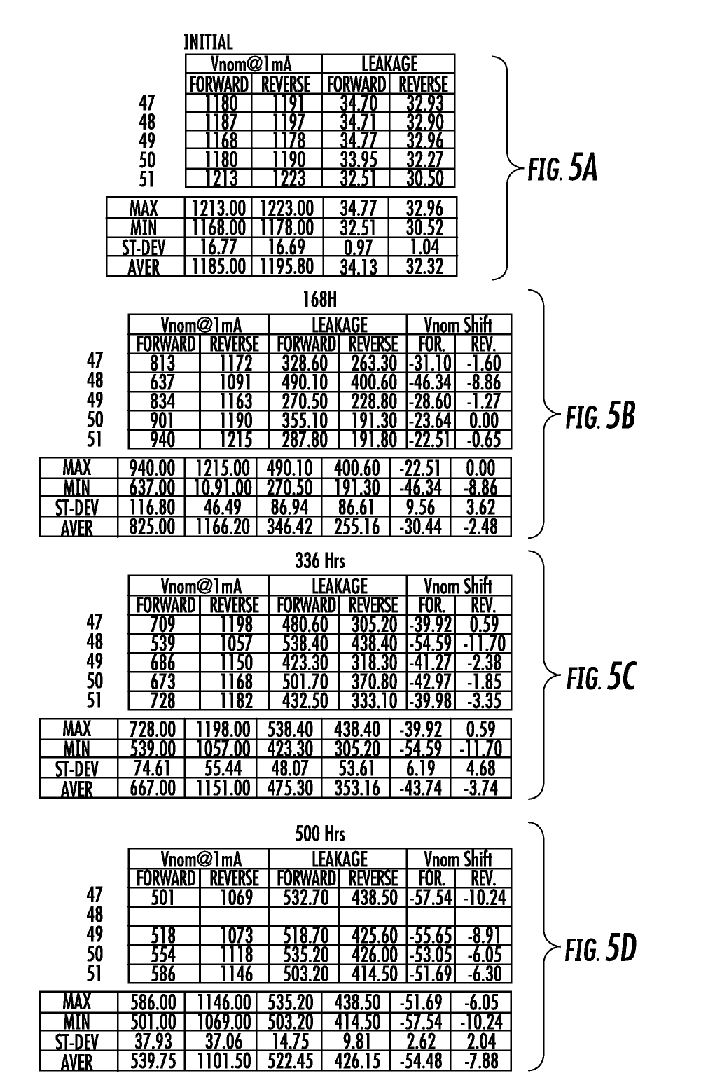

An advantage provided by the MOV devices according to the present embodiments is the improved performance under various conditions, including improved performance under high temperature loading tests (150° C. with 1500 V DC applied, 125° C. with 970 V DC applied), bias humidity loading test (85° C., 85% RH, with applied voltage up to 1500 V DC), and a hi-pot test (>2500 V AC applied). FIGS. 4A-FIG. 4D provide the results of electrical measurements of a set of MOV samples arranged with a two-layer coating according to the present embodiments. The MOV samples were subjected to various measurements at intervals of approximately 168 hrs while subject to applied bias. In particular, in one set of tests the MOV samples were subject to application of 970 V continuous dc bias at 85° C. and in an ambient of 85% relative humidity, while in another set of tests the samples were maintained at 125° C. with continuous 970 V DC applied. In FIGS. 4A-4D and 5A-5D results are shown for samples subjected to 970 V continuous dc bias at 85° C. and in an ambient of 85% relative humidity. Samples were removed and measured at intervals of approximately 168 hrs as noted. In the data shown, Vnom represents the voltage drop across an MOV when 1 mA current is conducted through the MOV, and leakage current is measured at 80% Vnom.

In FIG. 4A, a set of samples 42, 43, 44, 45, and 46 were measured for varistor voltage (Vnom) at 1 ma current, under forward bias and reverse-bias conditions. Leakage measurements are also shown under forward bias and reverse-bias conditions. The initial Vnom values exhibit an average of approximately 1190 under forward bias and 1200 under reverse-bias. These values increase marginally with time up to 500 hrs by approximately 1.3% and 2.5%, respectively. The leakage current (shown in Microamperes) is measured at a bias voltage of 80% Vnom, with both forward leakage and reverse leakage recorded. The initial leakage values under non-bias conditions exhibit an average value of approximately 32 and decrease slightly as a function of time. The initial leakage values under bias exhibit an average value of approximately 34, which varies slightly as a function of time, but does not show a systematic shift. These results indicate that the MOV is stable under the test conditions at least to 500 hrs.

FIGS. 5A-5D provide the results of electrical measurements of a conventional MOV arranged with a coating that contains a single epoxy layer. A set of samples 47, 48, 49, 50, and 51 were measured using the same measurement conditions as shown in FIGS. 4A-4D. As illustrated in FIG. 5A, the initial Vnom and leakage measurements exhibit substantially the same results as the sample measurements of FIG. 4A, as expected. However, the electrical properties change substantially as a function of time, as shown in FIGS. 5B, 5C, and 5D. For example, after 500 hrs, Vnom under reverse-bias conditions decreases by approximately 8% and under forward bias conditions decreases by approximately 54%. Moreover, after 500 hrs, under both non-bias and bias conditions, leakage increases by more than a factor of 10, indicating sever performance degradation.

In addition to the above advantages shown in the electrical property measurements of FIGS. 4A-4D, the two-layer coating of the present embodiments can be expected to exhibit anticreep behavior, quakeproof properties, dustproof properties, corrosion proof properties, salt spray proof properties, mildew proof properties, ageing resistance and corona resistance.

It is to be noted that the above results of FIGS. 4A-4D provide measurements for a two-layer MOV in which the inner layer is formed from a mixture of amine resin and acrylic resin, specifically, 40% acrylic resin, 7% amino resin, 35% xylol, 16% additional solvent, and 2% curing agent. However, in other embodiments, a two layer coating may be composed an inner layer of lacquer in which the relative amount of amino resin and acrylic resin differ from the above composition. Moreover, additional embodiments include a two layer coating in which the outer layer is composed of an epoxy and inner layer is composed of a thermoset material other that is formed by a combination of precursors other than amine resin and acrylic resin.

In further embodiments, a two layer coating may be applied to protect other electronic components from degradation under high voltage, high temperature, or high humidity conditions. Such electronic components include Positive Coefficient Temperature Thermistors (PTC Thermistor), Negative Coefficient Temperature Thermistors (NTC Thermistor), Resistors, Capacitors, Filters, Ferroelectric and piezoelectric components, and so forth.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A varistor, comprising:
a ceramic body; and
a multilayer coating disposed around the ceramic body, the multilayer coating comprising:
an outer layer comprising an epoxy material; and
an inner layer being adjacent the ceramic body and disposed between the outer layer and the ceramic body, the inner layer comprising a polymeric material that is composed of an acrylic component.

2. The varistor of claim 1, wherein the ceramic body comprises a ZnO ceramic.

3. The varistor of claim 1, wherein the inner layer comprises a thickness of 3 μm to 100 μm.

4. The varistor of claim 1, wherein the inner layer is derived from an acrylic resin and amino resin.

5. The varistor of claim 4 wherein a ratio of acrylic resin to amino resin is 3:1 to 19:1.

6. The varistor of claim 5, wherein a ratio of acrylic resin to amino resin is 6:1.

7. The varistor of claim 1, wherein a thickness of the outer layer is 0.3 mm to 3 mm.

8. The varistor of claim 1, wherein the outer layer does not contact the ceramic body.

9. A method of forming a varistor, comprising:
providing a ceramic body;
applying a first layer on the ceramic body, the first layer comprising an acrylic component; and
applying a second layer to the first layer, the second layer comprising an epoxy material.

10. The method of claim 9, wherein the ceramic body comprises a ZnO ceramic.

11. The method of claim 9, wherein the first layer comprises a thickness of 5 mm to 100 mm.

12. The method of claim 9, wherein the applying the first layer comprises:
providing a mixture comprising mixing an acrylic resin, amino resin, xylol solvent, and curing agent; applying the mixture to the ceramic body; and
curing the mixture to form a solid layer.

13. The method of claim 12, wherein a ratio of acrylic resin to amino resin is 3:1 to 19:1.

14. The method of claim 13, wherein a ratio of acrylic component to amino component is 6:1.

15. The method of claim 9, wherein the second layer does not contact the ceramic body.

16. The method of claim 9, wherein the applying the first layer comprises applying the first layer by brush coating, spray coating, dip coating, or curtain coating.
